(19) United States
(12) Patent Application Publication
(10) Pub. No.: US 2024/0026671 A1
(43) Pub. Date: Jan. 25, 2024

(54) INFORMATION OUTPUT DEVICE

(71) Applicant: Hitachi, Ltd., Tokyo (JP)

(72) Inventors: Masayuki OKAMOTO, Tokyo (JP); Masayuki AKATSU, Tokyo (JP); Kenji OTSUKA, Tokyo (JP)

(21) Appl. No.: 18/025,247

(22) PCT Filed: Nov. 12, 2020
(86) PCT No.: PCT/JP2020/042190

§ 371 Date: Mar. 8, 2023

(51) Int. Cl. E03D 9/00; G08B 21/02

(52) U.S. Cl. CPC E03D 9/00; G08B 21/02

(57) ABSTRACT

This information output device that outputs toilet congestion information to a user terminal includes a monitoring unit that gathers toilet usage status information indicating the usage statuses of toilets, an editing unit that edits, for each area formed by dividing a facility, the toilet usage status information of the toilets installed in each area, then creates toilet congestion information for each area, an area receiving unit that receives user information transmitted from a user terminal of a user who will use the toilets, then selects an area available to the user, and an information output unit that transmits the toilet congestion information associated with the selected area to the user terminal.

### TECHNICAL FIELD

The present invention relates to, for example, an information output device that provides toilet congestion information to a toilet user.

### BACKGROUND ART

Conventionally, a person who uses a toilet has only been able to know the vacant status of toilets after going into a toilet installation space where the toilets are installed. The toilet installation space is a specific space in an area that is divided into men's use and women's use and provided with a plurality of individual cubicles. Essentially, one toilet is installed in each individual cubicle.

If all the toilets in the toilet installation space are in a state of being occupied, a toilet user has to wait until an individual cubicle becomes vacant. However, in a case where there is a plurality of toilet installation spaces on one floor, even if one toilet installation space is congested, other toilet installation spaces may be vacant. Therefore, there has been demand from toilet users who want to go to another toilet installation space that is vacant and use a toilet there, even if it is a little far from their current location, if it means that they can use the toilet quickly.

“A toilet system provided with an acquisition unit that acquires identification information that is maintained by the terminal of a user who uses a toilet, a specifying unit that specifies output information that is to be provided to the user on the basis of the identification information acquired by the acquisition unit, and an output unit that outputs the output information specified by the specification unit” described in Patent Literature 1 is known as a technique for meeting such a demand.

### CITATION LIST

### Patent Literature

Patent Literature 1: JP 2014-213186 A

### SUMMARY OF INVENTION

### Technical Problem

While Patent Literature 1 describes that congestion information is generated and output, the technique described in Patent Literature 1 may display congestion information of toilets in areas not normally available to a user. Such congestion information is not useful information for the user. In addition, when congestion information of a large number of toilets is displayed on a user terminal, searching for congestion information of toilets in the area where the user is located takes a lot of effort.

### Solution to Problem

An information output device according to the present invention outputs toilet congestion information of toilets provided in a facility to a user terminal.

This information output device includes a monitoring unit that gathers toilet usage status information indicating a usage status of the toilets, an editing unit that edits, for each area formed by dividing a facility, the toilet usage status information of toilets installed in each area, then creates toilet congestion information for each area, an area receiving unit that receives user information transmitted from a user terminal of a user who will use the toilets, then selects an area available to the user, and an information output unit that transmits the toilet congestion information associated with the selected area to the user terminal.

### Advantageous Effects of Invention

According to the present invention, since the toilet congestion information associated with the area available to the user is output to the user terminal, the user can easily find the toilet congestion information of the toilets in the area available to the user.

### BRIEF DESCRIPTION OF DRAWINGS

FIG. 1 is a block diagram illustrating an overall configuration example of a toilet congestion information display system according to one embodiment of the present invention.

FIG. 2 is a block diagram illustrating an internal configuration example of a user terminal according to one embodiment of the present invention.

FIG. 3 is a block diagram illustrating a hardware configuration example of a computer (an information output device) according to one embodiment of the present invention.

FIG. 4 is a block diagram illustrating a hardware configuration example of a computer (an administrator terminal or a user terminal) according to one embodiment of the present invention.

FIG. 5 is a diagram illustrating a configuration example of an area information table according to one embodiment of the present invention.

FIG. 6 is a diagram illustrating a configuration example of a user information table according to one embodiment of the present invention.

FIG. 7 is a diagram illustrating a configuration example of a congestion information table according to one embodiment of the present invention.

FIG. 8 is a sequence diagram illustrating an example of processing when the user operates a user terminal during area registration according to one embodiment of the present invention.

FIG. 9 is a sequence diagram illustrating an example of processing for displaying toilet congestion information on a user terminal according to one embodiment of the present invention.

FIG. 10 is a diagram illustrating a display example of a management screen displayed on an administrator terminal according to one embodiment of the present invention.

FIG. 11 is a diagram illustrating a display example of a usage status screen displayed on a user terminal according to one embodiment of the present invention.

### DESCRIPTION OF EMBODIMENTS

Hereinafter, the embodiments of the present invention will be described with reference to the accompanying drawings. In the present specification and the drawings, constituent elements having substantially the same function or configuration are denoted by the same reference numerals to omit redundant descriptions.

### One Embodiment

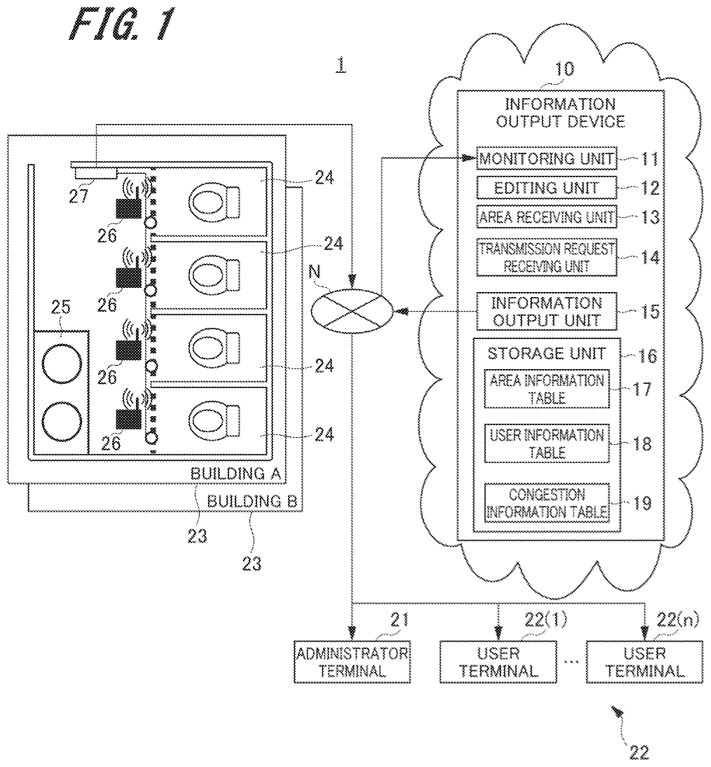

FIG. 1 is a block diagram illustrating an overall configuration example of a toilet congestion information display system 1.

The toilet congestion information display system 1 includes a toilet usage status detection unit 26 installed in each toilet 24, an information output device 10, an administrator terminal 21, and user terminals 22(1) to 22(n). In the following description, the user terminals 22(1) to 22(n) are referred to as user terminals 22 when no distinction is made between them.

### <Configuration of Area>

As an example, in facilities 23 identified by building names such as Building A and Building B, areas in which the toilets 24 are installed are provided in addition to offices (not illustrated) and the like. The toilets 24 are used by tenant employees, customers, or the like. However, in a case of a tenant occupying space across a plurality of floors, a user who is a tenant employee can use the toilets 24 installed on different floors occupied by the tenant.

In certain areas configured in the facilities 23, four toilets 24, a wash basin stand 25, the toilet usage status detection units 26, and a gateway device 27 are provided. The toilets 24 illustrated in FIG. 1 are sitting toilets provided in individual cubicles. Urinals may be used as the toilets 24.

The toilet usage status detection unit 26 is used in combination with, for example, a sliding sensor installed on a sliding lock of an individual cubicle or a human sensor that detects a user who has entered an individual cubicle and detects the toilet usage statuses indicating whether the toilets 24 are occupied. The toilet usage status information indicating whether the toilets 24 are occupied is used as an example of the usage information for each individual cubicle. The toilet usage status detection unit 26 transmits a signal (usage information), such as one that is turned on when a person is detected entering the individual cubicle (it is detected that an individual cubicle door is closed or a person has entered the individual cubicle) and is turned off when the person is detected exiting the individual cubicle (it is not detected that an individual cubicle door is closed or a person has entered the individual cubicle), to the gateway device 27.

For example, in a case where a sliding sensor is used, the toilet usage status detection unit 26 wirelessly transmits a locking detection signal with a unique identifier for each door to the gateway device 27 when the sensor detects that the door of the individual cubicle is closed and the door is locked. In addition, the toilet usage status detection unit 26 wirelessly transmits an unlocking detection signal to the gateway device 27 when the sensor detects that the door is unlocked.

Further, for example, in a case where a human sensor provided on the ceiling above each individual cubicle is used, the toilet usage status detection unit 26 wirelessly transmits an entry detection signal to the gateway device 27 when the human sensor detects that a person has entered the individual cubicle. In addition, when the human sensor no longer detects a person due to the person exiting the individual cubicle, the toilet usage status detection unit 26 wirelessly transmits an exit detection signal to the gateway device 27.

After receiving the signal wirelessly transmitted from the toilet usage status detection unit 26, the gateway device 27 creates the toilet usage status information generated in response to the signal for each individual cubicle and transmits the toilet usage status information to the information output device 10 via an internet N. The toilet usage status information includes identification information of the areas or the toilet installation spaces where the gateway device 27 is installed.

### <Configuration of Information Output Device>

Next, an internal configuration example of the information output device 10 will be described.

The information output device 10 provides the toilet congestion information of the toilets 24 provided in the facilities 23 to a user terminal 22. The information output device 10 includes a monitoring unit 11, an editing unit 12, an area receiving unit 13, a transmission request receiving unit 14, an information output unit 15, and a storage unit 16. The storage unit 16 includes an area information table 17, a user information table 18, and a congestion information table 19.

The monitoring unit 11 gathers the toilet usage status information indicating the usage statuses of the toilets 24 for each individual cubicle of the toilets 24 installed in the facilities 23. The toilet usage status information is gathered from the gateway device 27 provided in the toilet installation spaces via the internet N. Also, the monitoring unit 11 stores the usage statuses of the toilets 24 in the congestion information table 19 on the basis of the gathered toilet usage status information.

The editing unit 12 edits, for each area formed by dividing the facilities 23, the toilet usage status information of the toilets 24 and creates the toilet congestion information for each area. At this time, the editing unit 12 processes the congestion information for each area on the basis of the usage status of each individual cubicle with a toilet 24 with reference to the congestion information table 19. Note that in a case where there is a plurality of toilet installation spaces in one area, the toilet congestion information is created for each area and each toilet installation space. In this way, the editing unit 12 aggregates the toilet usage status information for each individual cubicle, and the processed information in units of area is referred to as the toilet congestion information. Also, the editing unit 12 stores the toilet congestion information created for each area in the storage unit 16 in association with a uniform resource locator (URL: an example of access information) associated with a storage region constructed in a network N.

The area receiving unit 13 receives user information transmitted from the user terminal 22 of the user who uses the toilets 24 and selects the areas available to the user. Note that other information may be used as the user information, and a mode in which other information is used will be described later.

The area receiving unit 13 receives an area selected by the user using a service for providing the toilet congestion information preferentially requesting the acquisition of the toilet congestion information. For example, in a case where the user can only move around a specific floor of a certain building, the user cannot go to the toilets 24 provided on other floors. Therefore, in a certain building, it is preferable that the toilet congestion information of the area on the specific floor is preferentially displayed on the user terminal 22. Accordingly, in a case where a plurality of areas are present, the area receiving unit 13 receives a priority order of the areas. Since the usage statuses of the toilets 24 in the areas selected by the user are preferentially displayed, the user can view the usage statuses of the toilets 24 in the areas. Note that, as will be described later, the area receiving unit 13 can also receive an area including the toilets 24 available to the user on the basis of position information acquired automatically by the user terminal 22.

The transmission request receiving unit 14 receives a transmission request for the toilet congestion information from the user terminal 22. When receiving the transmission request, the transmission request receiving unit 14 instructs the information output unit 15 to output the toilet congestion information.

The information output unit 15 transmits the toilet congestion information associated with the area selected by the area receiving unit 13 to the user terminal 22. At this time, the information output unit 15 transmits the toilet congestion information to the user terminal 22 on the basis of the priority order. For example, the priority order “1” is a high priority order. The information output unit 15 transmits the toilet congestion information to the user terminal 22 at the timing at which output is instructed by the transmission request receiving unit 14. However, the information output unit 15 may transmit the toilet congestion information to the user terminal 22 at fixed intervals.

The toilet congestion information displayed on the user terminal 22 is expressed on, for example, a later-described usage status screen W20 illustrated in FIG. 11. Also, the information output unit 15 outputs the toilet congestion information corresponding to the URL, that is, the URL corresponding to the area received by the area receiving unit 13, to the user terminal 22. Since the toilet congestion information does not include a URL indicating a location of a site that is accessible to anyone, it is possible to avoid unauthorized operations in which the user copies and pastes the URL and transfers it to another user.

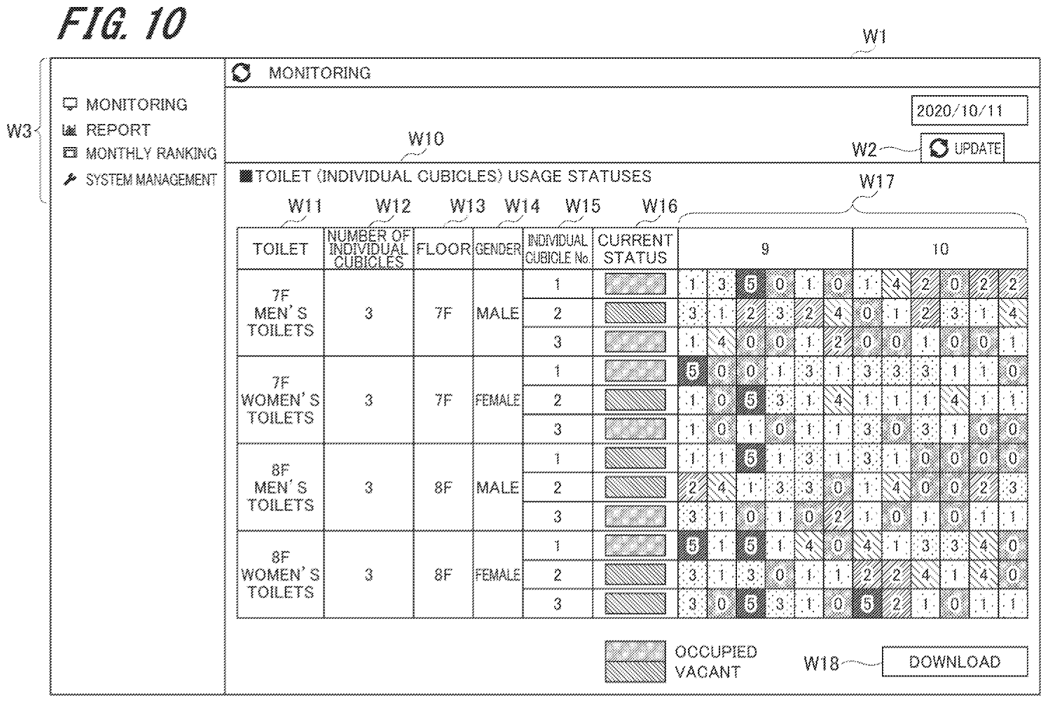

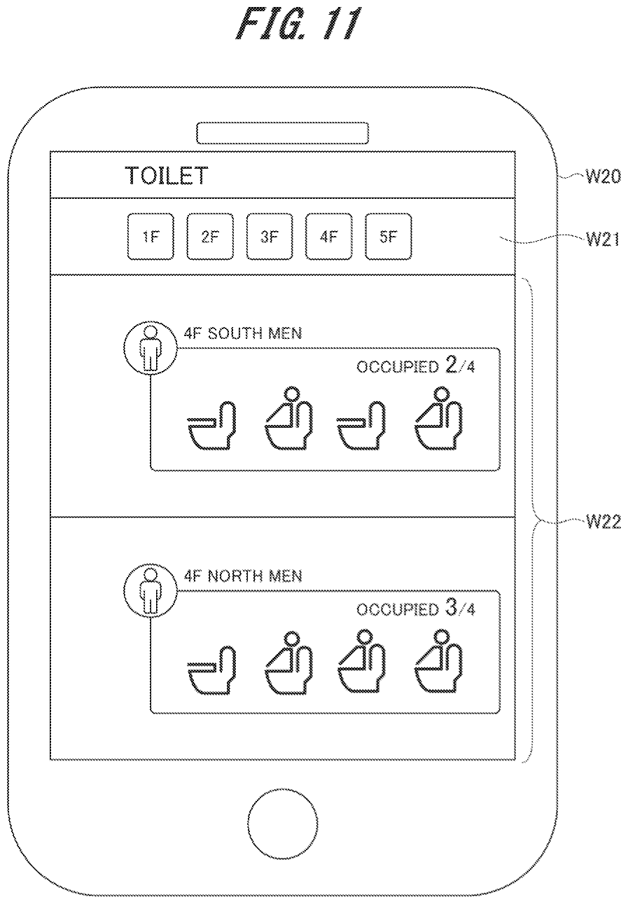

In addition, the information output unit 15 outputs the congestion information of the toilets 24 over an arbitrary period in the facilities 23, the areas, and the like arbitrarily selected by an administrator to an administrator terminal 21. The toilet congestion information output to the administrator terminal 21 that manages the toilet congestion information is information including transitions in usage statuses of the toilets 24 over a period designated by the administrator terminal 21. The toilet congestion information displayed on the administrator terminal 21 is expressed, for example, by a later-described management screen W1 illustrated in FIG. 10.

The user information table 18 is a table that stores the user information, such as affiliation information of users, areas where the toilets 24 available to the user are provided, and the like.

The area information table 17 is a table that stores area information.

The congestion information table 19 is a table that stores the congestion information.

Detailed configurations of the user information table 18, the area information table 17, and the congestion information table 19 will be described below with reference to FIGS. 5 to 7.

A storage unit 36 of the user terminal 22 stores URLs allocated to each tenant with which users are affiliated. For example, when requesting the acquisition of the toilet congestion information, the user, who is an employee of the tenant, selects the URL displayed on the user terminal 22 and accesses the information output device 10. When access from the user terminal 22 is detected, the editing unit 12 of the information output device 10 edits the toilet congestion information corresponding to the user terminal 22. Also, the information output unit 15 transmits the toilet congestion information to the user terminal 22.

Note that the toilet congestion information output by the information output unit 15 to the user terminal 22 is information including a number of toilets 24 installed in the areas edited by the editing unit 12 after the transmission request receiving unit 14 received the transmission request for the toilet congestion information, and a number of toilets 24 occupied in the area. By looking at the user terminal 22 on which the toilet congestion information is displayed, the user can confirm the vacant status of the toilets 24 in the areas available to the user and go to an area where there are vacant toilets 24.

### [Configuration Example of User Terminal]

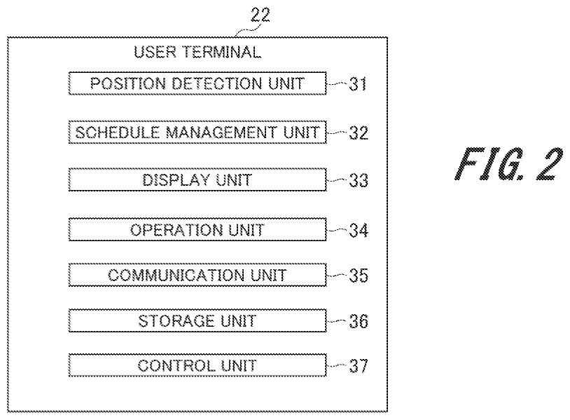

FIG. 2 is a block diagram illustrating an internal configuration example of the user terminal 22.

The user terminal 22 includes a position detection unit 31, a schedule management unit 32, a display unit 33, an operation unit 34, a communication unit 35, the storage unit 36, and a control unit 37.

The position detection unit 31 detects a current position of the user terminal 22. A global positioning system (GPS) signal receiving unit, for example, is used as the position detection unit 31. The GPS signal receiving unit receives a GPS signal from a satellite, then detects planar position information of the user terminal 22 for detecting a building where the user is located. Note that the position detection unit 31 can also detect the planar position information indicating the current position of the user terminal 22 on the basis of radio waves received from a wireless base station.

The GPS signal can be used by the information output device 10 to provide the toilet congestion information of a suitable building to the user terminal 22 in a case where there is a possibility that the user performs operations in a plurality of separate buildings.

For example, a beacon signal receiving unit may be used as the position detection unit 31. The beacon signal transmission device is small and lightweight, and is attached to a wall, a pillar, a ceiling, or the like on each floor and in each area. In addition, the transmission device can transmit beacon signals with a unique identifier attached. Therefore, the user terminal 22 including the beacon signal receiving unit can detect three-dimensional position information such as a floor number of the area where the user is located and a position in the area where the user is located on the basis of radio field intensity and the identifier of the received beacon signal.

Further, the position detection unit 31 may work together with an entry/exit management system that manages entry/exit to the facilities 23 and obtain information on the facilities 23 from the entry/exit management system. In this case, since the position detection unit 31 can accurately specify which facility 23 the user has attended, it is possible to provide suitable toilet information of the area in the specified facility 23.

The schedule management unit 32 manages the schedule of the user who operates the user terminal 22. For example, information such as an attendance schedule and a meeting schedule of the user, a place of a meeting room to be used for a meeting, and the like is managed together with usage times. Note that, the schedule management unit 32 may capture schedule information registered to an external service site accessed by the user terminal 22.

The display unit 33 displays information that can be provided to the user. For example, a screen for logging in to the service for providing toilet congestion information of the toilets 24 is displayed on the display unit 33. In addition, the display unit 33 displays a screen indicating usage statuses of the toilets 24 available to the user.

The operation unit 34 is used by the user to input arbitrary information. The user terminal 22 is used as a touch panel display in which the operation unit 34 and the display unit 33 are integrated. The user specifies the URL corresponding to the service for providing the toilet congestion information via the operation unit 34 to log in to a specific site where the service for providing the toilet congestion information is provided and register the areas that are normally available to the user. Some of the information operated by the user is transmitted to the information output device 10 via the communication unit 35.

The communication unit 35 is connected to the information output device 10 via the internet N. Also, the communication unit 35 transmits the position information of the user terminal 22 detected by the position detection unit 31 and the schedule information of the user managed by the schedule management unit 32 to the information output device 10. In addition, the communication unit 35 receives the toilet congestion information displayed on the display unit 33 from the information output device 10.

The storage unit 36 stores information operated by the user terminal 22 and user IDs for uniquely identifying the user terminal 22. The user ID and password input when the user operates the user terminal 22 and first logs in to the specific site where the service for providing the toilet congestion information is provided are stored in the storage unit 36. Therefore, when the user operates the user terminal 22 and logs in to the specific site the next and subsequent times, the user ID and password read from the storage unit 36 are automatically input in a login screen just by launching an application for providing congestion information. Further, the storage unit 36 can also store information on the areas available to the user.

The control unit 37 controls the processing of each unit in the user terminal 22. For example, the control unit 37 causes the position information of the user terminal 22 detected by the position detection unit 31 to be transmitted to the information output device 10 from the communication unit 35. In addition, the control unit 37 causes the schedule information managed by the schedule management unit 32 to be transmitted to the information output device 10 from the communication unit 35. Further, the control unit 37 requests that the information output device 10 transmits the toilet congestion information, and this transmission request is transmitted from the communication unit 35 to the information output device 10. In addition, the control unit 37 formats the toilet congestion information received by the communication unit 35 from the information output device 10 into a screen format that can be displayed on the display unit 33.

Here, four usage modes configured by combining the user information and the area receiving unit 13 will be described. Any one of the following four modes may be used alone, or several may be combined as appropriate.

(1) Mode in which the User Registers Areas and Priority Order

The user information according to this mode is information including the areas available to the user and the priority order designated by the user, which are input in the user terminal 22. The area receiving unit 13 can configure the priority order designated by the user for the areas available to the user. At this time, the user registers an area where the user normally stays and an order of high priority corresponding to the area in advance. Therefore, the toilet congestion information of the area registered in advance is preferentially set over areas where the user has rarely gone.

### (2) Mode of Using Schedule Information

The user information according to this mode is the schedule information of recorded destinations and times of stay managed by the schedule management unit 32. The area receiving unit 13 can prioritize the output of the toilet congestion information of the area associated with the position information of the user on the basis of the schedule information, with reference to the schedule information of the user. At this time, the area receiving unit 13 can reference the schedule information by transmitting a schedule information acquisition request to the user terminal 22 and receiving the schedule information managed by the schedule management unit 32 of the user terminal 22 from the user terminal 22. Further, the area receiving unit 13 may access the external service site using authentication information uniquely allocated to each user, capture the schedule information registered in the external service site, and reference the schedule information. When the schedule information is used in this way, for example, even for an area provided with a reception room where the user normally does not go, if the reception room has been recorded in the schedule information, the order of high priority is automatically configured for this area in accordance with the time the user goes to the reception room and the area to which the user has gone. Therefore, when the user who has gone to the reception room wants to use the toilets 24, the toilet congestion information of the area where the reception room is provided is preferentially displayed on the user terminal 22.

### (3) Mode of Automatically Configuring Areas

The user information according to this mode is the position information indicating the position of the user terminal 22. The position information includes at least one type of information from among information indicating the planar position of the user terminal 22 in the facilities 23 and information indicating the three-dimensional position (including floor number) of the user terminal 22. The area receiving unit 13 receives the position information of the user terminal 22 detected by the position detection unit 31 of the user terminal 22. The information output unit 15 preferentially transmits the toilet congestion information of an area within a range predetermined from the position of the user terminal 22. For example, in a case where the user moves around a plurality of buildings at different locations or moves between a plurality of floors in one building, when the areas are configured in advance, the number of areas for which the toilet congestion information is displayed on the user terminal 22 increases. However, in a mode in which the area receiving unit 13 automatically configures the areas, the areas are configured in accordance with the destination of the user, even if the user does not configure the areas. In addition, the order of high priority is configured for an area configured in accordance with the destination of the user. Therefore, the toilet congestion information of the area where the user is located is preferentially displayed on the user terminal 22. Note that the range predetermined from the position of the user terminal 22 includes not only a physical range, but also a logical range. For example, the range predetermined from the position of the user terminal 22 may be a physical range limited to within the same building and within the same floor where the user terminal 22 is present. In addition, the range predetermined from the position of the user terminal 22 may be set as, for example, a logical range that excludes areas that the user is prohibited to enter/exit, even if those areas are in the same building and on the same floor where the user terminal 22 is present.

### (4) Embodiment of Configuring Areas for Each Tenant

The user information according to this mode is a user ID for identifying the user operating the user terminal 22 (an example of user identification information). The area receiving unit 13 specifies a tenant, that is, an example of an organization with which the user is affiliated, on the basis of the user ID. In addition, the areas available to the user are allocated in advance for each tenant. Also, the area receiving unit 13 configures the priority order for each area allocated to the tenant in advance. Therefore, the information output unit 15 outputs the toilet congestion information to the user terminal 22 in the priority order configured for each tenant in accordance with the user ID transmitted from the user terminal 22. For example, in a case where there is only one tenant in one area, users affiliated with this tenant often use the toilets 24 provided in the one area. Therefore, even if the user does not individually configure the priority order, the toilet congestion information is provided to the user terminal 22 in the same order of priority for all the users affiliated with the tenant.

### <Hardware Configuration of Computer>

Next, a hardware configuration of a computer 40 configuring the information output device 10 will be described.

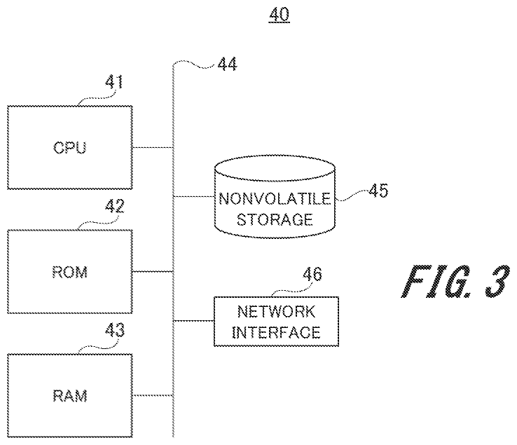

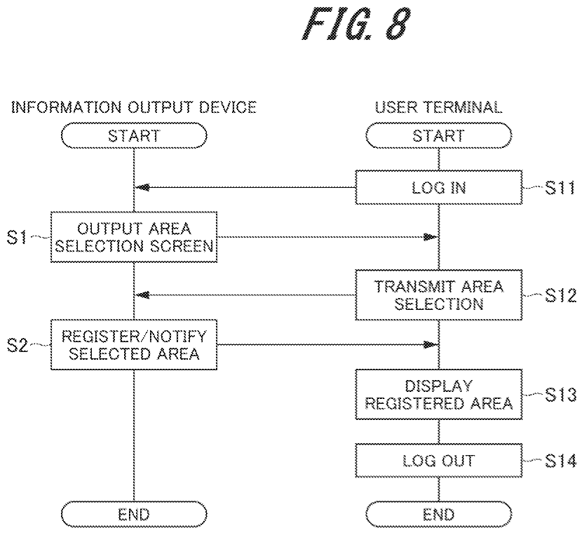

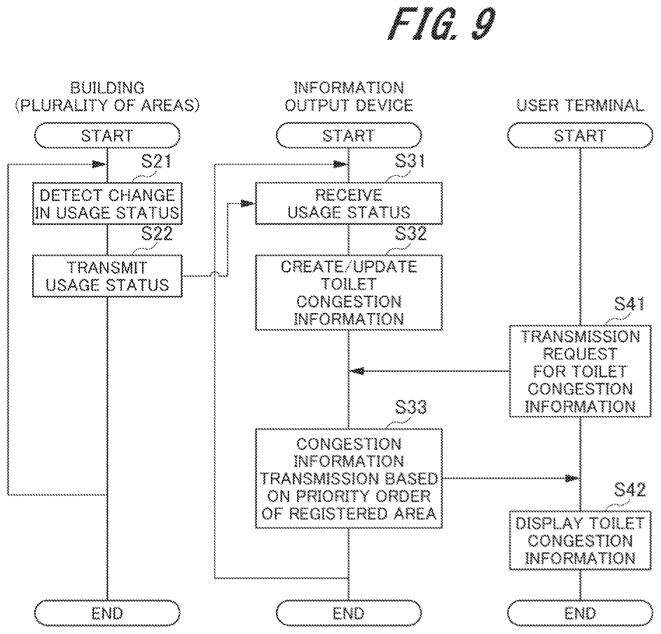

FIG. 3 is a block diagram illustrating a hardware configuration example of the computer 40. The computer 40 is one example of hardware used as a computer that can be operated as the information output device 10 according to the present embodiment. The information output device 10 according to the present embodiment realizes a toilet congestion information display method, performed by each functional block illustrated in FIGS. 8 and 9 working together, by the computer 40 (computer) executing a program.

The computer 40 includes a central processing unit (CPU) 41, a read only memory (ROM) 42, and a random access memory (RAM) 43 each connected to a bus 44. Further, the computer 40 includes a nonvolatile storage 45 and a network interface 46.

The CPU 41 reads a software program for realizing each function according to the present embodiment from the ROM 42, loads the program in the RAM 43, and executes the program. Variables, parameters, and the like generated during the arithmetic processing of the CPU 41 are temporarily written to the RAM 43, and these variables, parameters, and the like are read as appropriate by the CPU 41. However, a micro processing unit (MPU) may be used instead of the CPU 41. Functions of the monitoring unit 11, the editing unit 12, the area receiving unit 13, the transmission request receiving unit 14, and the information output unit 15 are realized by a program executed by the CPU 41.

A hard disk drive (HDD), a solid state drive (SSD), a flexible disk, an optical disk, a magneto-optical disk, a CD-ROM, a CD-R, a magnetic tape, a nonvolatile memory, or the like, for example, is used as the nonvolatile storage 45. In addition to an operating system (OS) and each type of parameter, a program for allowing the computer 40 to function is recorded in the nonvolatile storage 45. The ROM 42 and the nonvolatile storage 45 record programs, data, and the like necessary for operating the CPU 41, and they are used as one example of a computer-readable nonvolatile storage medium storing a program executed by the computer 40. For example, functions of the storage unit 16 are realized by the nonvolatile storage 45.

A network interface card (NIC) or the like, for example, is used as the network interface 46, and each type of data can be transmitted and received between devices via a local area network (LAN), a dedicated line, or the like connected to a terminal of the NIC. The processing by which the monitoring unit 11 receives the toilet usage status information from the gateway device 27 and the processing by which the information output unit 15 transmits the toilet congestion information to the administrator terminal 21 or the user terminal 22 are realized by the network interface 46.

Next, the hardware configuration of the computer 50 configuring the administrator terminal 21 or the user terminal 22 will be described.

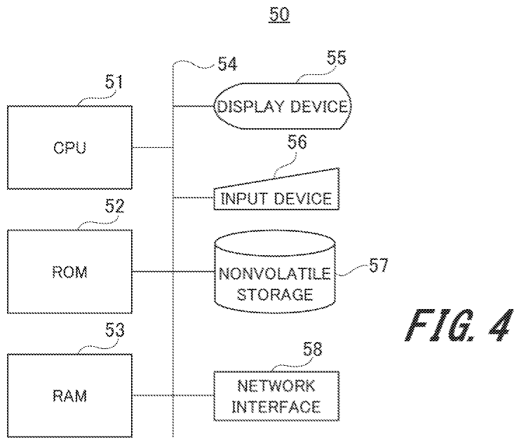

FIG. 4 is a block diagram illustrating a hardware configuration example of the computer 50. The computer 50 is one example of hardware used as a computer that can be operated as the administrator terminal 21 or the user terminal 22 according to the present embodiment. The administrator terminal 21 or the user terminal 22 according to the present embodiment realizes a toilet congestion information output method, performed by the each functional block illustrated in FIGS. 8 and 9 working together, by the computer 50 (computer) executing a program.

The computer 50 includes a CPU 51, a ROM 52, and a RAM 53 each connected to a bus 54. Further, the computer 50 includes a display device 55, an input device 56, a nonvolatile storage 57, and a network interface 58.

The CPU 51 reads a software program for realizing each function according to the present embodiment from the ROM 52, loads the program in the RAM 53, and executes the program. Variables, parameters, and the like generated during the arithmetic processing of the CPU 51 are temporarily written to the RAM 53, and these variables, parameters, and the like are read as appropriate by the CPU 51. However, an MPU may be used instead of the CPU 51. The functions of the position detection unit 31, the schedule management unit 32, and the control unit 37 are realized by a program executed by the CPU 51.

The display device 55 is, for example, a liquid crystal display monitor, and it displays the results of processing performed by the computer 50 or the like to the user or the administrator. A touch panel display or the like combined with the display device 55, for example, is used as the input device 56, in addition to a keyboard and a mouse, and therewith, the user or the administrator can perform predetermined input and instructions. The function of the display unit 33 is realized by the display device 55 and the function of the operation unit 34 is realized by the input device 56.

A HDD, an SSD, a flexible disk, an optical disk, a magneto-optical disk, a CD-ROM, a CD-R, a magnetic tape, a nonvolatile memory, or the like, for example, is used as the nonvolatile storage 57. In addition to an operating system (OS) and each type of parameter, a program for allowing the computer 50 to function is recorded in the nonvolatile storage 57. The ROM 52 and the nonvolatile storage 57 record programs, data, and the like necessary for operating the CPU 51, and they are used as one example of a computer-readable nonvolatile storage medium storing a program executed by the computer 50. The functions of the storage unit 36 are realized by the nonvolatile storage 57.

A network interface card (NIC) or the like, for example, is used as the network interface 58, and each type of data can be transmitted and received between devices via a LAN, a dedicated line, or the like connected to a terminal of the NIC. The functions of the communication unit 35 are realized by the network interface 58.

### <Configuration Example of Each Table>

Next, a configuration example of each table included in the information output device 10 will be described with reference to FIGS. 5 to 7.

### <Area Information Table>

FIG. 5 is a diagram illustrating a configuration example of the area information table 17.

In the area information table 17, the area information, including at least area categories and locations of the areas in the facilities, is defined for each area. The area information table 17 includes each field of tenant, facility, floor, area, category, and priority order.

The tenant field stores a tenant name for specifying a tenant for whom the toilet congestion information is managed. A tenant ID that can identify a tenant may be stored in the tenant field.

A name such as a building name or the like is stored in the facility field as one example of a facility occupied by the tenant.

The floor field stores floors (floor numbers) on which the areas stored in the area field are installed.

The area field stores information such as area names and area IDs for identifying the areas.

In the category field, initials representing women's (female) and men's (male) are stored as the categories of the toilets 24 provided in the areas.

The priority order is stored in the priority order field. The priority order is, for example, information that is referred to when the toilet congestion information is preferentially displayed on each user terminal 22. The higher the priority order, the more toilet congestion information of the toilets 24 in the area associated with this priority order is displayed on the user terminal 22. The priority order may be determined on the basis of the position of the user terminal 22, or it may be explicitly registered by the user. In a case where the user has not selected the area and the priority order by the later-described processing of FIG. 8., the priority order defined in the area information table 17 is stored in the priority order field of the user information table 18. However, in a case where the user has selected the area and the priority order, the priority order selected by the user is stored in the priority order field of the user information table 18.

In this way, the priority order is stored for each tenant in the area information table 17. For example, in a case where there is a plurality of toilet installation spaces that can be used in one or a plurality of areas occupied by a certain tenant, an order of high priority is often assigned to the toilet installation space near an entrance or an exit of the tenant.

Note that the area information table 17 may be provided in the storage unit 36 in the user terminal 22. In this case, the user terminal 22 stores the priority order of each area selected by the user in the storage unit 36. When the user terminal 22 accesses the service for providing the toilet congestion information, only the user ID is transmitted to the information output device 10. Also, on the basis of the received user ID, the information output device 10 transmits, to the user terminal 22, the toilet congestion information for the area associated with the tenant ID acquired with reference to a master user (not illustrated). Also, the user terminal 22 can display the toilet congestion information for each area received from the information output device 10 on the display unit 33 in accordance with the priority order for each area read from the storage unit 36.

### <User Information Table>

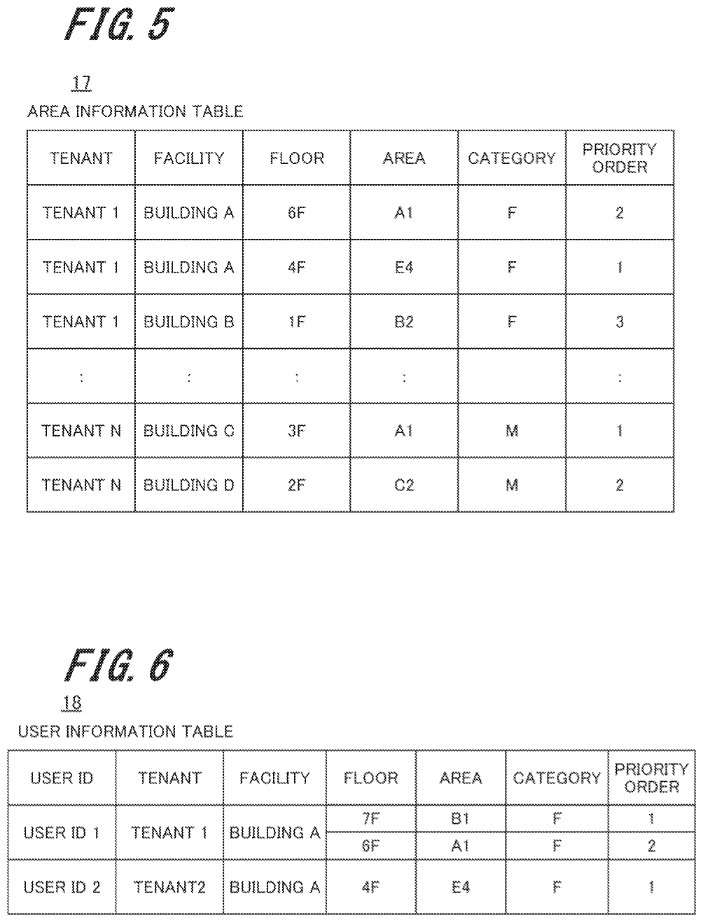

FIG. 6 is a diagram illustrating a configuration example of the user information table 18.

In the user information table 18, the user information is defined for each user ID. The user information table 18 has each field of user information including tenant, facility, floor, area, category, and priority order, in addition to user ID.

The user ID field stores user IDs for uniquely identifying the user. The user ID is associated with the user terminal 22, and a user who operates the user terminal 22 is specified thereby.

The contents of each field of tenant, facility, floor, area, category, and priority order are as described for the user information table 18.

In this way, the priority order for the areas individually selected by the user is configured in the user information table 18. Note that the information output device 10 may be configured not to include the user information table 18 according to the mode of the service for providing the toilet congestion information.

In addition, only the priority order of toilets for the gender of the user with the same gender of the user stored in the user information table 18 may be set to be configurable.

Note that, as described in “(3) Mode of automatically configuring areas”, the information output device 10 may dynamically change the priority order. For example, at whatever position the user carrying the user terminal 22 has moved to, the position detection unit 31 of the user terminal 22 detects the position by receiving a beacon signal or the like and transmits the position information of the user terminal 22 to the information output device 10. When the area receiving unit 13 of the information output device 10 recognizes that the position where the user terminal 22 is present is an area available to the user on the basis of the position information of the user terminal 22, the area receiving unit 13 configures the priority order of this area as high. In addition, the area receiving unit 13 assigns an order of high priority to areas having a toilet installation space where there are many vacant toilets 24 (degree of congestion is low) from among the areas available to the user. Also, the information output unit 15 outputs the toilet congestion information for the area selected in accordance with the priority order to the user terminal 22. Therefore, even if the user does not register the priority order of the areas in advance, the toilet congestion information of the area selected in accordance with the movement of the user is displayed on the display unit 33 of the user terminal 22.

In addition, if the mode is one in which the priority order is changed, the information output device 10 may be configured not to include the user information table 18, and the priority order field may be excluded from the area information table 17. In this case, the toilet congestion information edited by the editing unit 12 is output to the user terminal 22 in the order of areas with the most vacant toilets 24 to the least.

As another mode of dynamically changing the priority order, there is one mode in which the toilet congestion information of the area having a toilet installation space with many vacant toilets 24 from among the areas close to the user terminal 22 is output to the user terminal 22. For example, the area receiving unit 13 matches a location of the toilet installation space with the position information of the user terminal 22 (three-dimensional position information including buildings and floors). Also, the area receiving unit 13 requests the toilet installation space having many vacant toilets 24 from the toilet usage status information gathered by the monitoring unit 11 from among the toilet installation spaces near the user terminal 22. For example, the area receiving unit 13 configures the area having the toilet installation space with many vacant toilets as “1” and configures an area having a toilet installation space with few vacant toilets as “2”. Also, the information output unit 15 may output the toilet congestion information of the area having the toilet installation space with many vacant toilets 24 edited by the editing unit 12 to the user terminal 22. In such a mode, it is no longer necessary to store the priority order in the table.

### <Congestion Information Table>

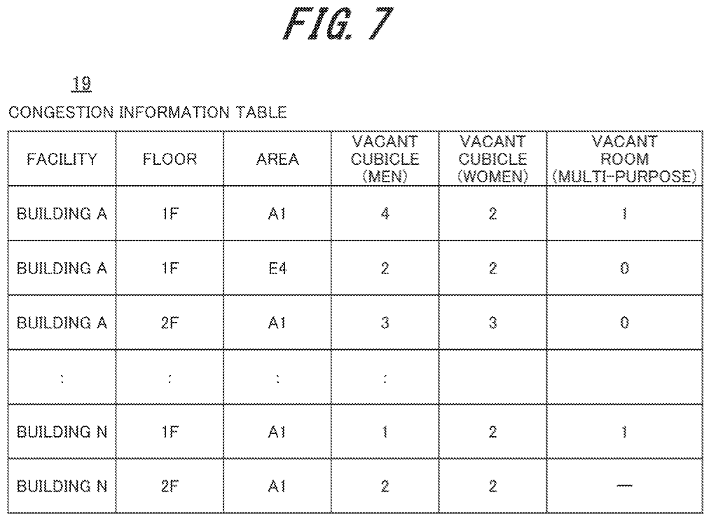

FIG. 7 is a diagram illustrating a configuration example of the congestion information table 19.

In the congestion information table 19, information indicating a vacant status of the toilets 24 (vacancy of individual cubicles) is stored for each of cubicles for men, cubicles for women, and multi-purpose rooms. The congestion information table 19 includes each field of facility, floor, area, vacant cubicle (men), vacant cubicle (women), and vacant room (multi-purpose). A number of vacant cubicles of zero means that all the individual cubicles or multi-purpose rooms in the toilet installation space are occupied.

The contents of the fields of facility, floor, and area are as described for the area information table 17.

The vacant cubicle (men) field stores the number of vacant individual cubicles that can be used in the toilet installation space for men for each area. If there are no toilet installation spaces for men, a hyphen is stored in this field.

The vacant cubicle (women) field stores the number of vacant individual cubicles that can be used in the toilet installation space for women provided in the area. If there are no toilet installation spaces for women, a hyphen is stored in this field.

The vacant room (multi-purpose) field stores the number of vacant multi-purpose rooms that can be used in the toilet installation space provided in the area. If there are no multi-purpose rooms, a hyphen is stored in this field.

Note that the number of toilets 24 installed in each toilet installation space may be stored in the vacant cubicle (men) field, the vacant cubicle (women) field, and the vacant room (multi-purpose) field.

### <Processing Example of Toilet Congestion Information Display System>

Next, an example of processing for each device performed in the toilet congestion information display system 1 will be described with reference to FIGS. 8 and 9.

### <Example of Processing During Area Registration>

FIG. 8 is a sequence diagram illustrating an example of processing when the user operates the user terminal 22 during area registration.

First, to use the toilet congestion information display system 1, the user launches an application program that provides the service for providing the toilet congestion information installed on the user terminal 22 to display the login screen. Then, the user inputs the identification information such as the user ID, password, and the like in the login screen to log in to the specific site of the service for providing the toilet congestion information (S11). In this login operation, information such as the user ID associated with the user terminal 22, the tenant ID for specifying the tenant available to the user, and the like is transmitted to the information output device 10.

The information output unit 15 of the information output device 10 outputs an area selection screen to the user terminal 22 (S1). Here, as is illustrated in the area information table 17 of FIG. 5, a range of buildings, floor numbers, areas, and the like for which the user can acquire the toilet congestion information is determined for each tenant. This is because the toilet congestion information of the areas that cannot be used by the user is not useful even if it is displayed on the user terminal 22. Accordingly, the information output unit 15 outputs, to the user terminal 22, the area selection screen generated on the basis of the user ID of the user who logged in in step S11. The area selection screen includes a list indicating a range for which the user can select the toilet congestion information.

For example, one tenant may occupy a plurality of buildings. In this case, even if the toilet congestion information of buildings where no users are present is displayed on the user terminal 22, the information is unnecessary for the user. In addition, if unnecessary information is mixed in, it takes time to obtain the toilet congestion information of the areas necessary for the user. Therefore, the user performs an operation of selecting, in advance, an area for which the user wants the toilet congestion information to be acquired via the area selection screen. After this operation, information for the selected area is transmitted from the user terminal 22 to the information output device 10 (S12).

The area receiving unit 13 of the information output device 10 registers the area information received from the user terminal 22 in the user information table 18, notifies the user terminal 22 of the information for the areas available (S2), and ends the present processing.

The display unit 33 of the user terminal 22 displays the area registered in the information output device 10 (S13). Then, the user terminal 22 logs out (S14) and ends the present processing.

Note that the user terminal 22 may transmit the position information of the place to which the user has moved detected by the position detection unit 31 to the information output device 10. In this case, the information output unit 15 of the information output device may generate the area selection screen on the basis of the position information received from the user terminal 22 and output the area selection screen to the user terminal 22. In this way, in the information output device 10, when the range of the toilet congestion information provided to the user terminal 22 is automatically registered on the basis of the places to which the user can move instead of the information on the tenant with which the user is affiliated, it is possible to omit the operations of selecting and transmitting the area by the user shown in step S12.

In addition, the processing of area registration by the user illustrated in FIG. 8 is necessary in the above-described “(1) Mode in which the user registers areas and priority order” and “(4) Embodiment of configuring areas for each tenant”. Since the areas are configured automatically in the other modes illustrated in (2) and (3), the user does not need to perform area registration processing. However, even for the modes illustrated in (2) and (3), the user may perform area registration processing.

### <Processing Congestion Information Display>

FIG. 9 is a sequence diagram illustrating an example of processing for displaying the toilet congestion information on the user terminal 22.

First, in a plurality of areas provided in a building, each toilet usage status detection unit 26 detects a change in the usage statuses of the toilets 24 (S21). Also, when detecting that the toilets 24 are occupied, the toilet usage status detection unit 26 wirelessly transmits detection results of changes in the usage statuses to the gateway device 27. When the gateway device 27 wirelessly receives the detection results of changes in the usage status for each individual cubicle, it transmits the detection results to the information output device 10 via the network N as information indicating the usage statuses of the toilets 24 in the toilet installation space (S22). Note that the processing in steps S21 and S22 may be executed each time the toilet usage status detection unit 26 detects a change in the usage statuses, or it may be executed at predetermined intervals of time. In addition, the processing in steps S21 and S22 ends outside the business hours of the building.

The monitoring unit 11 of the information output device 10 receives the information indicating the usage statuses transmitted from the gateway device 27 (S31). Also, the monitoring unit 11 passes information indicating the usage statuses to the editing unit 12. The processing in which the monitoring unit 11 receives the information indicating the usage statuses is performed at a fixed cycle, such as, for example, once per minute. However, the monitoring unit 11 may be set so as to gather the toilet usage status information when there is a change in the usage statuses of the toilets 24.

Next, the editing unit 12 creates the congestion information on the basis of the information indicating the usage statuses. The editing unit 12 creates the toilet congestion information at predetermined time intervals. Therefore, the editing unit 12 updates the previously created congestion information with the congestion information created at this time (S32).

The control unit 37 of the user terminal 22 causes the information output device 10 to transmit a transmission request for the toilet congestion information to the communication unit 35 at an arbitrary timing when the user wants to obtain the toilet congestion information (S41). After the processing in step S32, when the user terminal 22 transmits the transmission request for the toilet congestion information, the transmission request receiving unit 14 of the information output device 10 receives the transmission request for the toilet congestion information. The information output unit 15 transmits the toilet congestion information to the user terminal 22 on the basis of the priority order of the areas registered in advance in the area information table 17 by the processing illustrated in FIG. 8 (S33). At this time, the toilet congestion information transmitted to the user terminal 22 is the information that was edited by the editing unit 12 when the transmission request receiving unit 14 received the transmission request for the toilet congestion information. The processing in steps S31 to S33 is performed at a fixed cycle as described above, and the processing ends in a time zone during which the user terminal 22 does not request the congestion information (midnight or the like).

The display unit 33 of the user terminal 22 displays the congestion information received from the information output device 10 (S42) and ends the present processing. The user can check the displayed congestion information and go to an area with vacant toilets 24 in response.

### <Display Example of Screen>

Next, display examples of screens displayed on the administrator terminal 21 and the user terminal 22 will be described with reference to FIGS. 10 and 11.

### <Management Screen>

FIG. 10 is a diagram illustrating a display example of the management screen W1 displayed on the administrator terminal 21. The management screen W1 displays, for example, a list of toilet congestion information for each area aggregated every hour, for each toilet installation space. The administrator can update the contents displayed on the management screen W1 at an arbitrary timing.

The management screen W1 includes an update button W2 for updating the toilet congestion information at an arbitrary timing. When the administrator configures, for example, Oct. 11, 2020 as the date on which he or she wants to confirm the usage statuses of the toilets 24 and presses the update button W2, a list showing the usage statuses of the toilets 24 on this date for every hour is displayed in a usage status display area W10.

Each item of toilet W11, number of individual cubicles W12, floor W13, individual cubicle no., current status W16, hourly usage status W17, and download W18 are indicated in the usage status display area W10.

Toilet W11 stores the toilet installation space names together with the floor numbers. The toilet installation space names are, for example, 7F men's toilets and 7F women's toilets.

A number of individual cubicles (that is, the number of toilets 24) installed in the toilet installation space is stored in number of individual cubicles W12.

Floor W13 stores the floors (floor numbers) on which the toilet installation spaces are provided.

Gender W14 stores a gender of the user who can use the toilets 24.

Individual cubicle no. W15 stores individual cubicle numbers for identifying individual cubicles where the toilets 24 are installed.

Current status W16 stores the usage statuses of the toilets 24 for each individual cubicle number. The usage statuses of the toilets 24 can be identified by either pattern of “occupied” or “vacant” indicated at a lower portion of the usage status display area W10. For example, when the user selects the update button W2, the current status of each individual cubicle is updated and displayed when the update button W2 is selected by the area receiving unit 13, the transmission request receiving unit 14, the information output unit 15, and the congestion information table 19 making up an application programming interface (API) working together in the information output device 10.

Hourly usage status W17 indicates how much the toilets 24 have been used per hour (every hour and every ten minutes). For example, a number of times that a fixed door is opened/closed every ten minutes is stored in each cell.

Download W18 is a button for downloading data indicating the usage statuses of the toilets 24 for each area displayed on the usage status display area W10.

A selection menu W3 provided on a left-hand side of the management screen W1 is a menu for the administrator to select a display mode of the congestion information displayed on the management screen W1. The display mode illustrated in FIG. 10 is displayed by selecting monitoring from the selection menu W3. In addition, while not illustrated, the congestion information edited by the editing unit 12 is displayed on the management screen W1 in a display mode such as reports, monthly rankings, or system management.

By grasping the usage statuses of the toilets 24 via the management screen W1, the administrator using the administrator terminal 21 can respond in at least one of the following four ways.

### (1) Confirmation of Usage for a Long Period of Time

In a case where it can be identified that the toilets 24 have been occupied for a long period of time without the door of a certain individual cubicle being opened or closed for a long time, there is a possibility that the user has come down with a sudden illness or the like in the individual cubicle. It is necessary to consider such a user as a person in need of help and immediately rescue them. Therefore, it is possible to put the invention to good use in detecting and rescuing persons in need of help.

In addition, inappropriate uses can be assumed, such as that the user is operating the user terminal 22 for a long period of time in the individual cubicle to access non-work sites, or that the user is sleeping. Even in such a case, the administrator can detect inappropriate long time use. Accordingly, the administrator can head to the toilet installation space where the corresponding toilets 24 are located and warn the user that long time use is inappropriate.

### (2) Grasping Usage Frequency of Toilets 24

The toilets 24 that are frequently occupied become dirty easily. Therefore, the administrator can suitably deploy cleaning staff by increasing or decreasing the number of times cleaning is carried out in accordance with the usage statuses of the toilets 24.

In addition, if the toilets 24 are frequently occupied, consumables such as toilet paper, disinfectant, and the like are used up quickly. Accordingly, the administrator can grasp an appropriate amount and an appropriate time to refill consumables in advance.

### (3) Grasping Usage Statuses of Toilets 24

In addition, in a case where the administrator is contacted by a user wanting to use a toilet 24 that the specific toilet 24 has been occupied for a long time, the administrator can grasp the usage status of the toilet 24 over a specific period of time via the management screen W1. Since the usage statuses of the toilets 24 are managed in this way using objective data, the administrator can easily warn the user who has occupied the toilet 24 for a long time.

### (4) Consultation on Toilet Installation

In addition, the administrator can grasp the usage statuses of the toilets 24 in accordance with user attributes, such as a gender ratio of employees affiliated with the tenant or customers and the like visiting the building. Therefore, it is possible to put the invention to good use during consultations on toilet installation, such as proposing an appropriate number of toilets 24 in light of the user attributes for each area or the like to a business operator of a building or the like where toilets are to be newly installed.

### <Usage Status Screen>

FIG. 11 is a diagram illustrating a display example of the usage status screen W20 displayed on the user terminal 22. The usage status screen W20 displays a list of congestion information of the toilets 24 in the areas available to the user. For example, when the user operates the user terminal 22 and logs in to the specific site via the application for providing the congestion information, the usage status screen W20 indicating the usage statuses of the toilets 24 during login is displayed on the user terminal 22.

The usage status screen W20 includes an area selection unit W21 and an area-specific congestion information display unit W22.

The area selection unit W21 is an item with which the user instructs a selection in a case where an area (for example, 3F) the user wants to display is different from an area (for example, 4F) currently displayed on the area-specific congestion information display unit W22. When the user selects the item 3F, the congestion information for 3F is displayed on the area-specific congestion information display unit W22.

The area-specific congestion information display unit W22 displays the congestion information of the toilets 24 in the areas available to the user by area. A 4F south area and a 4F north area illustrated as examples of areas in the drawings are areas for which the user wants to preferentially display the congestion information of the toilets 24. Therefore, when the user logs in to the specific site via the application for providing the congestion information, the congestion information of the 4F south area and the 4F north area is displayed.

Also, the fact that two toilets 24 out of the four toilets 24 in the men's toilet installation space in the 4F south area are occupied is displayed on the area-specific congestion information display unit W22 by icons and a numerical value. Similarly, the fact that three toilets 24 out of the four toilets 24 in the men's toilet installation space in the 4F north area are occupied is displayed by icons and a numerical value. Therefore, the user can choose to go to an area having a larger number of vacant toilets 24 from among the two available areas.

Note that the display mode of the congestion information may be represented by a degree of congestion [%] defined by the number of occupied toilets/the number of available toilets in the toilet installation space×100, in addition to the icons and the number of vacant individual cubicles. In addition, the areas may be categorized into different colors, such as blue when the toilet installation space is vacant, yellow when it starts to become congested, and red when all the cubicles are occupied.

In the toilet congestion information display system 1 according to the above-described embodiment, the congestion information of the toilets 24 in the areas available to the user is provided to the user terminal 22. For this reason, since only the toilet congestion information of the toilets 24 in the areas available to the user is displayed on the user terminal 22, it is easier to grasp the usage statuses of the toilets 24 that the user wants to use.

In addition, the user frequently browses the toilet congestion information of toilet installation spaces in frequently used areas. Therefore, the congestion information indicating the usage statuses of the toilets 24 in the area frequently used by the user is preferentially provided to the user terminal 22 in order that the toilet congestion information in the target area can only be obtained by the user starting up the user terminal 22 and accessing the service for providing the toilet congestion information.

Note that when the user confirms that the toilets 24 installed in a certain area are congested, the user can request the acquisition of toilet congestion information of other areas available to the user. Also, the information output device 10 provides the toilet congestion information of the other areas to the user terminal 22. Therefore, the user can confirm the usage statuses of the toilets 24 in the other areas and choose to go to another area depending on the situation.

In addition, by registering the gender (category) of the user in the user information table 18, the toilet congestion information displayed on the user terminal 22 can be set as the toilet congestion information for a user with the same gender registered in the user information table 18, or it can be displayed limited to the toilet congestion information for a user with the same gender registered in the user information table 18.

Since these display methods depend on the intended usage of the facilities 23 where the toilets 24 are installed and the administrator policy, the administrator may change the settings of the display method on the administrator terminal 21.

In addition, the administrator can check the usage statuses of the toilets 24 installed in each area from a bird's eye view via the management screen W1. Also, the administrator can acquire the objective data regarding the usage statuses of the toilets 24. Therefore, if certain toilets 24 are occupied for a long time, it is possible to draw attention to the users of the toilets 24 or carry out consultations in accordance with the usage statuses of the toilets 24 in accordance with the gender ratio of employees affiliated with the tenant.

Note that the present invention is not limited to the above-described embodiment, and various other application examples and modification examples can be included as long as these do not deviate from the gist of the present invention described in the claims.

For example, the above-described embodiment gives a detailed and specific explanation of the configurations of the system and the device in order to explain the present invention in an easy-to-understand manner, and is not necessarily limited to an embodiment having all the described configurations. In addition, for a part of the configuration of the present embodiment, it is also possible to add, delete, and replace with other configurations.

Further, control lines and information lines indicate what is considered necessary for the description and are not necessarily limited to all the control lines and the information lines indicated on a product. In reality, almost all the configurations can be considered as being mutually connected.

### REFERENCE SIGNS LIST

1 Toilet congestion information display system
10 Information output device
11 Monitoring unit
12 Editing unit
13 Area receiving unit
14 Transmission request receiving unit
15 Information output unit
16 Storage unit
21 Administrator terminal
22 User terminal
23 Facility
24 Toilet
26 Toilet usage status detection unit
27 Gateway device
31 Position detection unit
32 Schedule management unit
36 Storage unit
W1 Management screen
W10 Usage status display area
W20 Usage status screen

1. An information output device that outputs toilet congestion information of toilets provided in a facility to a user terminal comprising:
a monitoring unit that gathers toilet usage status information indicating usage statuses of the toilets;
an editing unit that edits, for each area formed by dividing the facility, the toilet usage status information of the toilets installed in the each area, then creates the toilet congestion information for the each area;
an area receiving unit that receives user information transmitted from the user terminal of a user who will use the toilets, then selects an area available to the user; and
an information output unit that transmits the toilet congestion information corresponding to the area that has been selected to the user terminal.

2. The information output device according to claim 1, wherein the area receiving unit receives a priority order of areas in a case where there is a plurality of areas, and
the information output unit transmits the toilet congestion information to the user terminal on the basis of the priority order.

3. The information output device according to claim 2, wherein the user information is information including areas available to the user and the priority order designated by the user, which are input to the user terminal,
and the area receiving unit configures the priority order designated by the user for the areas available to the user.

4. The information output device according to claim 2, wherein the user information is schedule information in which destinations and times of stay of the user are recorded, and
the area receiving unit prioritizes the output of the toilet congestion information of areas associated with the position information of the user on the basis of the schedule information with reference to the schedule information of the user.

5. The information output device according to claim 2, wherein the user information is position information indicating a position of the user terminal detected by a position detection unit comprised in the user terminal,
the area receiving unit receives the position information of the user terminal detected by the position detection unit of the user terminal, and
the information output unit preferentially transmits the toilet congestion information of areas in a predetermined range from the position of the user terminal.

6. The information output device according to claim 5, wherein the position information includes at least one type of information from among information indicating the planar position of the user terminal in the facility and information indicating a three-dimensional position of the user terminal.

7. The information output device according to claim 2, wherein the user information is user identification information that identifies the user, and
the area receiving unit specifies an organization with which the user is affiliated on the basis of the user identification information and configures a priority order for each area allocated to the organization in advance.

8. The information output device according to claim 3, wherein the monitoring unit gathers the toilet usage status information when there is a change in the usage statuses of the toilets, and
the editing unit creates the toilet congestion information at predetermined time intervals.

9. The information output device according to claim 3, wherein the editing unit stores the toilet congestion information created for the each area in association with access information associated with a storage region constructed in a network, and
the information output unit outputs the toilet congestion information corresponding to the access information, which is the access information corresponding to the areas received by the area receiving unit, to the user terminal.

10. The information output device according to claim 3, comprising a transmission request receiving unit that receives a transmission request for the toilet congestion information from the user terminal, wherein
the toilet congestion information output to the user terminal is information including a number of the toilets installed in the areas edited by the editing unit after the transmission request receiving unit received the transmission request for the toilet congestion information and a number of the toilets occupied in the areas, and
the toilet congestion information output to an administrator terminal that manages the toilet congestion information is information including transitions in usage statuses of the toilets over a period designated by the administrator terminal.
